(19) United States
(12) Patent Application Publication
(10) Pub. No.: US 2025/0335363 A1
(43) Pub. Date: Oct. 30, 2025

(54) Transaction and Request Buffers for Cache Miss Handling

(71) Applicant: Tenstorrent USA, Inc., Austin, TX (US)

(72) Inventors: Miles Robert Dooley, Austin, TX (US); Abilash Sekar, San Jose, CA (US); Deepak Panwar, Austin, TX (US); Luke Yen, Woodinville, WA (US); Apurv Ravindra Narkhede, Santa Clara, CA (US)

(21) Appl. No.: 19/089,026

(22) Filed: Mar. 25, 2025

Related U.S. Application Data
(60) Provisional application No. 63/640,186, filed on Apr. 29, 2024.

(51) Int. Cl. G06F 12/0891

(52) U.S. Cl. CPC G06F 12/0891; G06F 2212/6022

(57) ABSTRACT

Methods and systems for cache miss monitoring and fulfillment are disclosed. A disclosed method comprises receiving, from a processing unit, a cache access request, determining, based on a cache failing to fulfill the cache access request, that a cache miss has occurred, populating a request buffer based on the cache miss and the cache access request, populating a transaction buffer with a transaction entry for the request buffer based on the cache miss request and the cache access request, determining by the request buffer, that information requested in the cache access request should be retrieved from main memory, determining, by the transaction buffer if information was not retrieved, that the cache access request satisfies criteria for creating a cache miss tag, creating the cache miss tag based on the cache access request, and storing the cache miss tag in a portion of the cache.

### CROSS REFERENCE TO RELATED APPLICATIONS

This application claims the benefit of U.S. Provisional Patent App. No. 63/640,186, as filed on Apr. 29, 2024, which is incorporated by reference herein in its entirety for all purposes.

### BACKGROUND

Caches play a pivotal role in computer architecture, serving as high-speed buffers between computational elements (e.g., a CPU) and main memory. Their primary function is to store frequently accessed data and instructions, thereby reducing the latency associated with fetching them from slower main memory. The frequently accessed data can be stored in a line of the cache. The line can include a tag for the data and the data itself. The tag can include the memory address of the data, which is used by the computational elements to identify the data, and the status of the data. The status can indicate that the data in the cache is valid, indicate that the data is outdated data that must be refreshed, or other information regarding the data.

When a computational element requests data that isn't present in the cache, it results in a cache miss. Cache misses are handled by fetching the required data from main memory and storing it in the cache for future access. While handling a cache miss, caches are often designed to keep a record of the cache miss so that new requests for the data can be queued for service from the same response that is provided for the first miss. Efficient handling of cache misses is crucial for maximizing system performance in modern computing environments.

Cache misses are often administrated using a component known as a Miss Status Handing Register (MSHR). When a cache miss occurs, the MSHR acts as a buffer for storing a record of the cache miss. The MSHR can store the tag for the missed data and hold a blank space for the data when it is retrieved from main memory. The MSHR can be made of fast memory such as registers or flip flops. When a cache miss has been responded to, the associated entry in the MSHR can be discarded and overwritten. By intelligently managing memory requests, the MSHR enhances the overall efficiency of the cache subsystem, optimizing system performance in handling cache misses.

In alternative approaches, cache misses can be administrated using the cache tags in the cache itself. For example, upon detecting a cache miss, the cache can evict an entry in the cache and store the tag for the missed data in the newly available entry. The entry can include a blank space for the data where the data will be held when it is retrieved from main memory. In this manner, when the data is retrieved, a complete entry in the cache has been formed to service later requests for the data. The benefit of this approach compared to those which use an MSHR is that a separate data structure is not required because the cache is already designed to hold data.

### SUMMARY

Systems and methods related to caches for computer systems are disclosed herein. In specific embodiments, the caches are designed to process a large number of cache misses with minimal latency as compared to prior approaches. As used herein, the term cache includes both the memory in which the cached data is stored and the control logic and ancillary data structures that allow for the processing of requests to the cache. The memory in which the cached data is stored is referred to as the cache memory in contrast to the main memory which the cache accesses in case of a cache miss. In specific embodiments, the cache is described using the example of a level one (L1) cache of a processor such as a CPU. However, the approaches disclosed herein are broadly applicable to any form of cache memory at any level servicing any form of computational element including GPUs, TPUs, and other processing units. Furthermore, while a cache miss to a cache is described as leading to an access to a main memory throughout this disclosure, all the disclosures of cache misses herein can alternatively lead to an access to a next level of the cache hierarchy.

In specific embodiments of the inventions disclosed herein, the caches include a first data structure with a first number of large data entries that can store a cache tag and the data associated with that tag, and a second data structure with a larger number of data entries where each data entry is smaller than the data entries in the first data structure. The data entries in the second data structure store indexes into either that first data structure or the cache. The data entries can also store an indicator as to which data structure they serve as an index for. The first data structure and the second data structure can be formed of any fast memory such as registers or flip flops. In specific embodiments, the first data structure can be referred to as a request buffer. In specific embodiments, the second data structure can be referred to as a transaction buffer.

Prior art approaches in which the cache itself is used to keep track of cache misses are beneficial when considered in light of those which use ancillary high-speed data structures such as MSHRs because of the cost of those ancillary high-speed data structures. However, using either approach by itself has significant latency issues. For example, using a portion of the cache itself for cache miss tracking takes much longer than access via the high-speed MSHR. Cache based approaches exhibit latency drawbacks in that evicting an entry from the cache to process the next allocated cache miss (i.e., the tag and a blank space for the data) takes a certain amount of time. The cache must determine which entry to evict and engages in a certain degree of book-keeping overhead before the entry can be evicted, such that writing over an entry in a MSHR is much easier and does not exhibit the latency drawbacks associated with evictions from the cache. On the other hand, an MSHR has storage limitations and during heavy cache miss events may not be able to handle all cache miss requests. Where an MSHR is not exposed to such overloaded cache miss conditions, high cache miss events can be managed. In specific embodiments of the invention disclosed herein, architectures such as those in accordance with the prior paragraph provide for indirect status handling of cache requests such that cache misses can be tracked using small data structures (e.g., pointers) to either a MSHR type structure or a portion of the cache, with an equivalent level of cache miss tracking capabilities as a MSHR without a limited number of entries, and without the latency drawbacks associated with tracking the miss using the cache itself or an overloaded MSHR.

In specific embodiments of the invention, a method for cache miss monitoring and fulfillment is provided. The method comprises receiving, from a processing unit, a cache access request, determining, based on a cache failing to fulfill the cache access request, that a cache miss has occurred, populating a request buffer based on the cache miss and the cache access request, populating a transaction buffer with a transaction entry for the request buffer based on the cache miss request and the cache access request, determining by the request buffer, that information requested in the cache access request should be retrieved from main memory, determining, by the transaction buffer if information was not retrieved, that the cache access request satisfies criteria for creating a cache miss tag, creating the cache miss tag based on the cache access request, and storing the cache miss tag in a portion of the cache.

In specific embodiments of the invention, a system for cache miss monitoring and fulfillment is provided. The system comprises means for receiving a cache access request from a processing unit, means for determining that a cache miss has occurred based on a cache failing to fulfill the cache access request, means for populating a request buffer based on the cache miss and the cache access request, means for populating a transaction buffer with a transaction entry for the request buffer based on the cache miss and the cache access request, means for determining, by the request buffer, that information requested in the cache access request should be retrieved from main memory, means for determining, by the transaction buffer, if the information was not retrieved, that the cache access request satisfies criteria for creating a cache miss tag, means for creating the cache miss tag based on the cache access request, and means for storing the cache miss tag in a portion of the cache.

In specific embodiments of the invention, a system for cache miss monitoring and fulfillment is provided. The system comprises a processing unit configured to generate memory access requests, a cache communicatively coupled to the processing unit for storing frequently accessed data, a memory subsystem comprising lower level memory coupled to the cache and configured to fulfill memory access requests that may result in cache misses, a request buffer coupled to the cache, the request buffer configured to track memory access requests corresponding to cache misses, and a transaction buffer coupled to the cache and the request buffer, configured to indirectly track status of cache misses using transaction entries which can reference either an entry in the request buffer or an entry in a cache miss tag section. The lower-level memory comprises a lower-level cache or system memory. The transaction buffer is configured to monitor the request buffer to determine if data may be lost from the request buffer. Memory access requests corresponding to cache misses are moved to a cache miss tag in a section of the cache whereupon the transaction entry is updated to point to the cache miss tag.

### BRIEF DESCRIPTION OF THE DRAWINGS

The accompanying drawings illustrate various embodiments of systems, methods, and other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is diagram of a cache miss handling architecture in accordance with specific embodiments of the invention.

FIG. 2 is diagram showing memory use of components of a cache miss handling architecture in accordance with specific embodiments of the invention.

FIG. 3 illustrates a process of handling cache misses in accordance with specific embodiments of the invention.

FIG. 4 illustrates a process of handling cache misses in accordance with specific embodiments of the invention.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems related to cache miss monitoring and fulfillment in accordance with the summary above are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

In specific embodiments of the inventions disclosed herein, a first data structure can serve to record the status of a cache miss by storing both a tag of the requested data and a blank space for the requested data. The associated entry can be written to the first data structure quickly upon the detection of a cache miss. A second data structure can store an index into the first data structure which may include a tag for the data and a pointer to the associated entry for the data in the first data structure. Both steps can be conducted quickly. At the same time, the cache can be working on evicting an entry to make room to track the cache miss. As an eviction becomes necessary or optimal, the cache miss data can be transferred to the cache entry and the index in the second data structure can be updated to be an index into the cache. The index can include control information (e.g., where the cache miss data is stored, and a validity value) for the data and a pointer to the associated entry for the data in the cache. The old entry that was tracking the cache miss in the first data structure can then be made available to track a new cache miss. In this manner, the first data structure can be used to track cache misses at high speed temporarily until the cache miss data needs to be transferred to the cache to find space for the next cache miss. This process thereby eliminates latency issues attributable to the cache making space to track cache misses. Also, since the first data structure is not overloaded and thus does not need to have extra entries, and the entries of the second data structure are relatively small, the overall architecture is not as expensive in terms of memory and supporting hardware as those which would have to use an expanded MSHR during heavy cache miss situations.

In specific embodiments, the first data structure will only need to be large enough to store recent cache misses while the processing works to move entries to the cache and make entries available in the first data structure. In specific embodiments, the first data structure will have 32 entries. The second data structure will have a number of entries equal to the number of cache misses that will be tracked simultaneously. In specific embodiments, the second data structure will have a multiple of the number of entries of the first data structure, such as 256 entries. The cache miss data for the remaining entries not in the first data structure is stored in the portion of the cache allocated to cache miss data.

In this manner, a new style of a MSHR is implemented which utilizes a level of indirection to enable cache miss tracking to happen in more than one underlying structure, to satisfy the competing constraints of minimizing cache miss latency as well as maximizing the number of cache misses that can be tracked. A request buffer akin to a typical MSHR provides a relatively small number of dedicated fast trackers, which can be allocated and utilized with minimal latency. In addition, a transaction buffer is a second data structure which acts as the primary tracker for the entire lifetime of the miss request. The transaction buffer provides a level of indirection, to enable the miss request tracking to be offloaded from the smaller/faster request buffer to a larger/slower tracker, and additional requests under high cache miss loads to be stored in a portion of the cache tags themselves allocated to cache miss tracking.

Request buffer entries are relatively expensive to implement in terms of hardware cost, so it is not practical to implement many of those. The transaction buffer entries are very inexpensive to implement, so it is practical to implement many of those. In addition, the cache tags themselves are relatively plentiful, and can also be utilized for tracking the outstanding requests, but doing so typically requires that we first remove some existing entry from the cache prior to using that space to track a new outstanding request. This step of removing (or evicting) a line from the cache before the new miss can be tracked would mean that the new miss request would be delayed in processing until the eviction takes place, and that delay is detrimental to performance.

When the miss is first seen, it will allocate both a transaction buffer entry as well as the request buffer entry, so that the miss handling of the request buffer can begin immediately. The miss request is tracked through the transaction buffer entry, which may include a pointer to either the request buffer or the cache tags that are processing the cache miss (e.g., “cache miss tags”). In the beginning the transaction buffer points to the request buffer. In the meantime, the process begins evicting something from the cache, to make space so that this new miss request can be tracked in the cache miss tags as necessary. Once space is available in the cache tags (e.g., something has been evicted from the cache), the tracking can be moved to the cache tags, and with such a move the transaction buffer is updated to point to the cache miss tag, and the request buffer entry is released for use by another miss. In this manner, the combined system gains the benefit of the low latency as well as the ability to track a large number of outstanding requests.

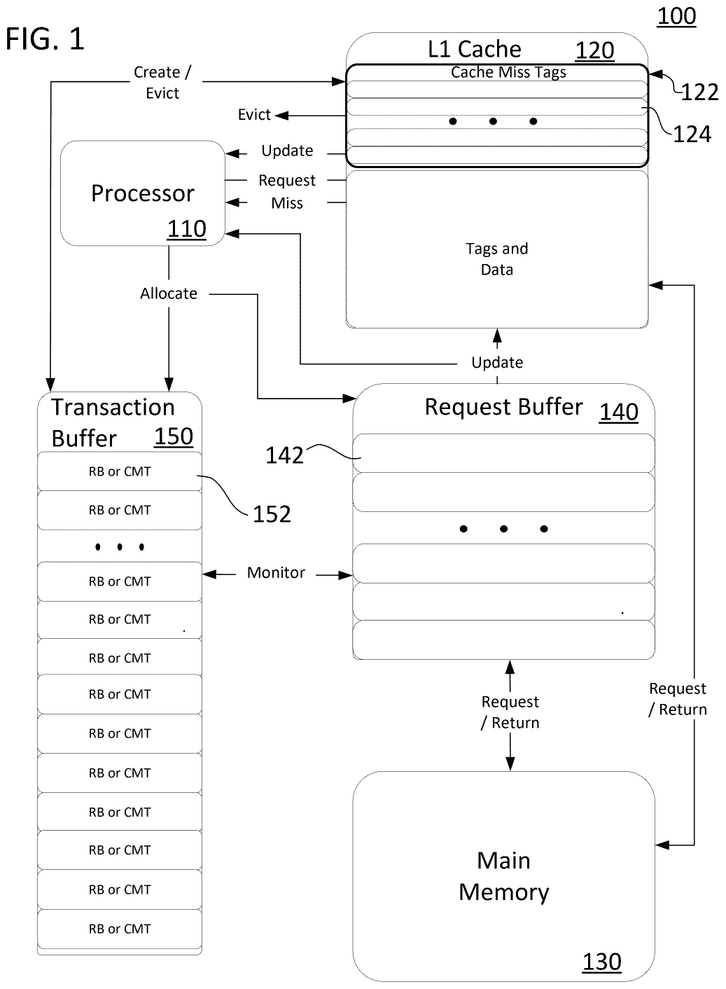

FIG. 1 illustrates an exemplary cache miss handling architecture 100 in some embodiments of the present disclosure. The depiction of FIG. 1 is simplified for purposes of illustration, and it will be understood that additional components may be included in other implementations (e.g., memory controllers, buffers, registers, etc.), that depicted components may be implemented with multiple components that may not be specifically depicted, and that substitutions of components may be made in certain implementations.

In the exemplary embodiment a processing unit, such as the depicted processor 110, accesses memory to temporarily store and access data that is used in performing operations such as component calculations of a complex calculation that is split among multiple processors and/or cores including processors. Although the present disclosure will refer generally to a processor or processing unit, it will be understood that this includes and that the present disclosure can be implemented with any suitable processing/control circuitry and combinations thereof, such as CPUs, graphics processing units (GPUs), tensor processing units (TPUs), tensor stream processors (TSPs), quantum processing units (QPUs), ASICs, and FPGAs.

The processor has access to multiple memory units or types, including local memory 120 such as an L1 cache, L2 cache, L3 cache, or other local memory, as well as system memory, each of which may be implemented with a variety of memory technologies and combinations thereof, such high bandwidth memory (HBM), static random-access memory (SRAM), dynamic random access memory (DRAM), and data double rate memory (DDR). Frequently accessed data is generally stored at and accessed from faster memory that is physically and/or electrically “closest” to the processor and thus has the shortest access time or latency. For purposes of this disclosure, local memory 120 such as this will be referred to as a L1 cache, although in other implementations other memory units or multiple memory units may function as the primary data store for frequently accessed data. Other data is available via the main memory 130, which refers to additional memory such as a L2 cache or L3 cache or could otherwise be system memory. Typically, the L1 cache is more costly to implement per unit of data that can be stored than the other memories, with a hierarchy of memories to slower access but larger memory units within the main memory.

The request buffer 140 includes a memory and related processing circuitry for handling cache misses where the requested information from the processing unit is not in the top-level cache (e.g., the L1 cache 120). In specific embodiments, the request buffer 140 is implemented with an MSHR, although other memory and circuitry may be utilized that satisfies the fast access and overwriting characteristics of the request buffer. Compared to other memory and circuitry, the request buffer is relatively expensive to implement, as each entry within the request buffer includes both information about the cache access request (e.g., address and control information) and temporary storage for the requested data when accessed from the main memory. Thus, the request buffer typically has a relatively small number of entries such as 32 entries.

As depicted in FIG. 1, in addition to the typical tags and data of the cache, the L1 cache 120 includes a section 122 of cache miss tags. Although the cache miss tags may be located in different areas of different caches, in an embodiment they are located within the tag section of the L1 cache, i.e., the same cache in which the requested data was unavailable (e.g., because the address could not be found, because the data was invalid, data coherency issues, etc.). Accordingly, the cache miss tags may include information about the cache access request that resulted in the cache miss, such as an address for the data and control information. In some embodiments, this may be the same information that is typically stored in a cache tag for the L1 cache, such that when data from a cache miss is retrieved the cache miss tag simply becomes the cache tag for that data. In any event, based on somewhat less information (e.g., without temporary storage of the accessed data) being required to be stored in the cache miss tag entries versus the request buffer entries, and relatively more space for cache miss tag entries due to overall memory size, the cache miss tags can typically accommodate hundreds of cache miss entries. In an example of 224 entries, this is seven times the 32 entries that may be stored in the request buffer. When data is accessed from the main memory, the tag and data for the cache access request are updated within the tag and data section of the L1 cache, while the cache miss tag is evicted. In some instances, for example, if a cache miss tag has been pending for an extended period without being fulfilled, or the cache miss tag portion of the L1 cache is becoming full, it may also be necessary to evict cache miss tags. In other instances, eviction can be performed when a cache tag is instantiated as a cache miss tag, such as to evict the previously stored cache tag and its underlying data. In such a configuration, the cache miss tag becomes an active cache tag once the data is retrieved and stored in the data entry corresponding to that cache tag.

The transaction buffer 150 stores information to manage the cache misses between the request buffer and the cache miss tag section 122 of the L1 cache. The transaction buffer can be located at any local fast access memory, and requires relatively little memory space. In general, the transaction buffer includes a limited amount of control information (e.g., 1-4 bits) and an address pointer based on a known addressing format of each of the cache miss tags and the request buffer. For example, to address the request buffer 140, the transaction buffer address pointer may merely need to be large enough to specify each of the entries within the request buffer (e.g., 5 bits for a 32-entry request buffer), while a pointer to an entry within the cache miss tags merely requires an index and way within the cache tag space where the cache miss tags are implemented (e.g., 12 bits for a 10 bit index and 2 bit way format). Example control information can include priority information, request type, validity information, pointer type, and other similar information. In an example of control information including validity information and a pointer type, the validity information may include a single bit indicating whether the entry is valid (e.g., can be overwritten within the request buffer or evicted from the cache miss tags) and a single bit pointer type may indicate whether the pointer is to the request buffer or the cache miss tags. In some embodiments, the pointer type may be implicit based on the known addressing format of the addressing index.

In an embodiment as depicted in FIG. 1, the processor 110 may unsuccessfully perform a cache access request from the L1 cache 120, resulting in a cache miss. Based on the cache miss, a request buffer entry 140 is allocated with information about the cache access request, for example, in the access and control sections of the entry. Allocating the cache miss to a particular entry of the request buffer overwrites the prior entry. The determination of which entry of the request buffer to use may be performed in a predetermined manner (e.g., first-in, first-out), can be based on control information within the cache access request, can be based on information within the transaction buffer indicating older request buffer entries or entries that have been fulfilled and/or are no longer valid, can be based on other suitable criteria, or can be based on combinations thereof. The allocation also results in population of an entry 152 in the transaction buffer 150, for example, with a validity control value indicating that the cache miss processing is active and valid, pointer type information indicating that the pointer for the cache access request is to the request buffer, and the corresponding address within the request buffer. This process continues for each cache miss, with the cache access requests initially being allocated to the request buffer and their statuses being tracked by the transaction buffer.

The cache misses are processed by the request buffer, with the cache access request being forwarded to the main memory to identify and return the requested data. When the data corresponding to the cache access request is successfully returned, the data is temporarily stored in the data portion of the request buffer entry until the L1 cache is populated and the data corresponding to the cache access request may then be sent to the processor. The transaction buffer monitors the request buffer status, and once the request is fulfilled, may invalidate or overwrite the entry corresponding to the fulfilled request within the transaction buffer.

During times of heavy cache use the cache misses may occur more frequently than the request buffer can access the data from the main memory, such that cache access requests that are still active within the request buffer would be overwritten before they can be fulfilled. The transaction buffer monitors the status of the request buffer entries, and prior to a request in the request buffer being overwritten, causes the cache access request to be populated within the cache miss tags portion of the L1 cache, for example, by causing the same control data within the request buffer entry to be populated within an entry of the cache miss tags, for example cache miss tag 124. The transaction buffer then updates its entries to indicate that the particular cache access request is now being processed based on the data of the cache miss tags, such as by updating the entry (e.g., the pointer type and address) or invalidating the request buffer entry and creating a cache miss tag entry.

In periods of heavy cache usage, it may be necessary to evict entries within the cache tags to accommodate additional entries. Rather than performing this process sequentially, in which an eviction must occur prior to creating additional cache tag entries, or where evictions may interfere with access requests in accordance with the cache miss tag entries, by tracking cache miss tag entries and request buffer entries through the transaction buffer, cache evictions can be timed to avoid interference with cache miss tag requests, for example, based on the request buffer fulfilling a substantial portion of requests. Thus, based on the transaction buffer coordinating between the request buffer and cache miss tags, the overall efficiency of access by the cache miss tags is also increased. When a request to the main memory is fulfilled, the tag and data entries within the L1 cache are updated for the cache access request, and the requested data is returned to the processor.

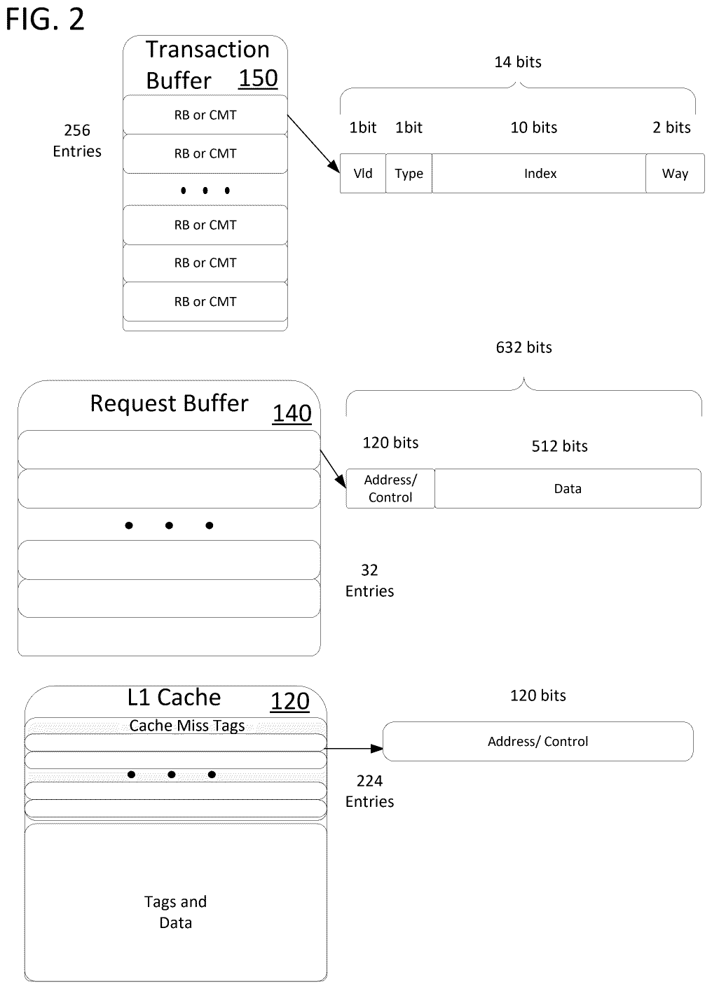

FIG. 2 depicts exemplary memory usage of the transaction buffer, request buffer, and cache miss tags portion of the L1 cache in accordance with an embodiment of the present disclosure. Although particular numbers of entries within each portion of memory are depicted in FIG. 2, and each entry includes particular information occupying a particular number of bits, it will be understood that memory allocations may be performed in different manners in accordance with different expected cache miss loads, memory constraints, and the like. For example, the request buffer may be larger than 32 entries to accommodate faster fulfillment of higher volumes of cache misses, and/or the number of cache miss tags may be increased to allow processing of a large number of cache misses, which in turn may require more bits of address information to be included in the transaction buffer. Further, more or additional control and address may be required in different embodiments.

As depicted in FIG. 2, an exemplary transaction buffer 150 has 256 entries and each entry requires 14 bits of storage. The 256 entries correspond to the total number of possible entries between both the request buffer (32 entries) and the cache miss tags of the L1 cache (up to 224 entries as cache miss tag usage increases). Each entry includes a validity bit which indicates whether the entry is active/valid, a pointer type bit which indicates whether the data is stored in the request buffer or cache miss tags of the L1 cache, and address data for either the cache miss tag entry or the request buffer entry (e.g., in FIG. 2 depicted for a cache miss tag entry by index and way, but requiring a different address format for the request buffer pointer). The request buffer 140 in turn includes 32 entries that may be referenced via the address data of the transaction buffer entry pointer and 632 bits of storage for address/control information (e.g., 120 bits) and temporary data storage (e.g., 512 bits). The cache miss tags 120 of the L1 cache that may be referenced via the address data of the transaction buffer entries includes up to 224 entries with each entry including address and control information (e.g., 120 bits). Accordingly, the transaction buffer 150 provides the ability to coordinate cache miss handling between the request buffer 140 and cache miss tags 120 with relatively little additional memory usage and processing overhead.

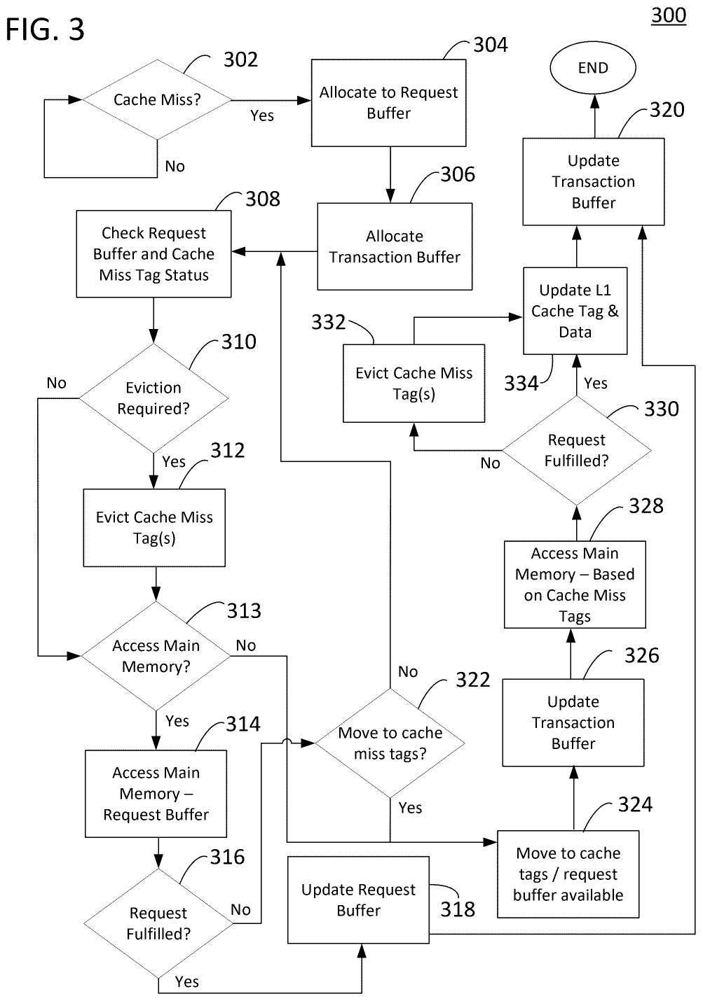

FIG. 3 depicts exemplary steps for processing of a cache miss in accordance with embodiments of the present disclosure. Although a set of steps are depicted in an order in FIG. 3, it will be understood that the processing of FIG. 3 may be modified, such as by removing or replacing steps, modifying the order of steps, and adding additional steps, while still performing a coordination between a request buffer and cache miss tags of a memory (e.g., L1 cache) in implementations of this disclosure. The processing of FIG. 3 tracks a cache miss through the entire life cycle from the initial identification of the cache miss through each option for processing of the cache miss. For each additional cache miss that occurs, the processing of FIG. 3 will be repeated. Processing of additional cache misses can be consecutive or can be concurrent with other cache misses. During conditions where cache misses are frequent, it may be more likely that the processing steps of utilizing the cache miss tags (e.g., starting at step 324) or even evicting an unfulfilled cache miss (e.g., at step 334 via step 332) may be required. In conditions of relatively infrequent cache misses, most cache misses will be processed via the request buffer (e.g., steps 308-318).

Processing begins at step 302, where it is determined whether there has been a cache miss. So long as the cache access request can be fulfilled from the relevant cache (e.g., L1 cache), the loop at step 302 continues. If the cache access request results in a cache miss, processing continues to step 304.

At step 304, the cache access request is allocated to the request buffer (e.g., an MSHR request buffer), for example, including populating (e.g., via overwriting) an existing request buffer entry with control and address information for the cache access request. The corresponding entry can also include space for temporary storage of the retrieved data for the cache access request (e.g., when retrieved from the main memory) prior to distribution to the cache (e.g., L1 cache) and processor. Once the cache access request has been allocated to the request buffer, processing continues to step 306.

At step 306, the transaction buffer is allocated based on the allocated cache access request. Because the cache access request is initially allocated to the request buffer, the transaction buffer is allocated with information for identifying the cache access request as active and valid (e.g., a validity bit), that the request is presently being handled by the request buffer (e.g., a pointer type bit), and an address for the cache access request within the request buffer. Once the transaction buffer is allocated, processing continues to step 308.

At step 308, the statuses of the request buffer and cache miss tags are checked. For example, the request buffer is checked to determine how many entries are active and whether an overwrite of an entry is likely to occur, while the cache miss tags are checked for which of its requests are active and the status of those requests (e.g., timing, status of main memory access, continued misses, etc.). Once information about the request buffer and cache miss tags is obtained, processing continues to step 310.

At step 310, it is determined whether an eviction is required from the cache. For example, during periods where there is a heavy concentration of cache misses, the request buffer will not be able to handle all the cache access requests and requests will need to be transferred to the cache miss tags. To move the entry (e.g., address and control information for the cache access request) to an entry of the cache miss tags, a previous cache entry may need to be evicted from the cache. If an entry or entries are to be evicted from the cache miss tags, processing continues to step 312. If eviction is not required, processing continues to step 314.

At step 312, the entry of the cache miss is evicted, resulting in that entry being open to population with cache access request that was previously being handled by the request buffer. By performing evictions preemptively, the evictions can be staged such that the cache miss tags are available to be populated prior to the request buffer being overwritten, preventing conditions where data is lost due to overwriting within the request buffer prior to transfer to the cache miss tags, and preventing sequences of operations where main memory access is delayed while evictions are performed. Because the cache miss tag portion of the cache allocated in the cache can store many more cache miss entries than the request buffer, it is less likely to fill up unless requiring a sudden eviction unless cache miss events are occurring at a very high rate. Performing evictions preemptively allows the system to operate smoothly all the way up to peak capacity without significant latency in processing cache miss requests. Processing then continues to step 313.

At step 313, it is determined whether an attempt to access main memory to fulfill the cache access request should occur. If it is predicted that data may be lost due to overwriting space in the request buffer before a main memory request can be fulfilled, the memory access can be deferred and the process can skip to step 324 where the cache request is moved to the cache miss tags portion of the L1 cache. If it is determined that main memory should be accessed, then processing continues to step 314.

At step 314, via the information in the request buffer, the main memory is accessed in an attempt to fulfill the cache access request. As noted, the processing steps of the flow chart in FIG. 3 can be modified in alternative embodiments. For example, step 313 or step 314 can occur immediately after the execution of step 306 depending on load conditions or other factors. In some cases, step 313 may be omitted entirely and the main memory access can be normally attempted. This and other modifications are possible in different embodiments and the steps can be reordered or executed in parallel so long as the data used in a processing step is not generated by a proceeding step. Processing then continues to step 316, wherein it is determined whether the cache access request has been fulfilled due to the request buffer receiving the requested data from the main memory. If the cache access request has been fulfilled, processing continues to step 318. If the cache access request has not been fulfilled, processing continues to step 322.

At step 318, if the cache access request has been determined to be fulfilled at step 316, the request buffer clears the cache miss by first updating its internal data buffer and then, via that data buffer, causing an update to the L1 cache to include the requested data and propagating the requested data to the processor. Once the L1 cache has been updated, processing continues to step 320.

At step 320, when reached via step 318, the transaction buffer is updated. For example, once it is known that the L1 cache has been updated and the original cache access request has been fulfilled, the corresponding entry within the transaction buffer may be cleared or updated (e.g., by changing the validity bit), such that it is known that the entry of the request buffer is available to be overwritten. With the cache access request that resulted in the cache miss satisfied and the transaction buffer updated, processing may end after step 320.

Returning to step 322, if the cache access request was not fulfilled at the request buffer via the main memory, it is determined whether the cache access request needs to be transferred to the cache miss tags. For example, based on the status of the entry within the request buffer (e.g., pendency, location within buffer, number of available buffer entries, etc.) it may be determined that the cache access request corresponding to the cache miss is going to be overwritten or is likely to be overwritten within the request buffer, such that the cache access request is to be transferred to the cache miss tags. Performing this step preemptively avoids cache access requests being inadvertently overwritten within the request buffer. If the cache access request is to be transferred to the cache miss tags, processing continues to step 324. If the cache access request is not to be transferred at the present time, processing returns to step 308 and the processing to continue the loop of checking the request buffer.

At step 324, the cache access request is transferred to an entry of the cache miss tags, for example, by providing information based on the address and control information of the request tag entry to an available entry within the cache miss tags, which may have just been previously evicted. The timing of the transfer is performed such that the cache miss tag entry is populated prior to the request buffer entry being overwritten, for example, based on a predicted or known time when the request buffer entry will be overwritten or not permitting the entry to be overwritten until creation of the entry in the cache miss tags is confirmed. Processing then continues to step 326.

At step 326, the transaction buffer is updated based on the transfer of the cache access request to the cache miss tags. For example, an entry of the transaction buffer that was previously associated with the request buffer entry may be updated such as by changing its pointer type bit and adding the index and way for the cache miss tag entry within the cache tags of the L1 cache. In another example, a new entry within the transaction buffer may be created for the cache miss tag entry and the prior entry for the request buffer entry may be set as invalid. Processing may then continue to step 328.

At step 328, via the information in the cache miss tag entry for the cache access request, the main memory is accessed in an attempt to fulfill the cache access request. Processing then continues to step 330, wherein it is determined whether the cache access request has been fulfilled due to the requested data being retrieved from the main memory. If the cache access request has been fulfilled, processing continues to step 334, where tag and data entries within the L1 cache are updated and the data is propagated to the processor. If the cache access request has not been fulfilled, processing continues to step 332, where an unfulfilled cache request can be evicted from the cache miss tag. In some embodiments, instead of immediately evicting the cache miss tags in step 332, one or more additional attempts to access main memory can be made in step 328.

At step 320, when arrived at via step 334, the cache miss tag has been evicted and at step 334 the transaction buffer is updated based on the cache miss tag no longer having information to service the cache access request that was originally missed at step 302. For example, the validity bit may be set to a value to indicate the entry is not valid based on eviction being required before the data was retrieved (e.g., via step 332) to allow further processing of this information, or may be set to invalid based on the data being evicted. In other examples, the entry may be deleted. Once the transaction buffer has been updated based on the eviction and/or the manner of the eviction, the processing ends.

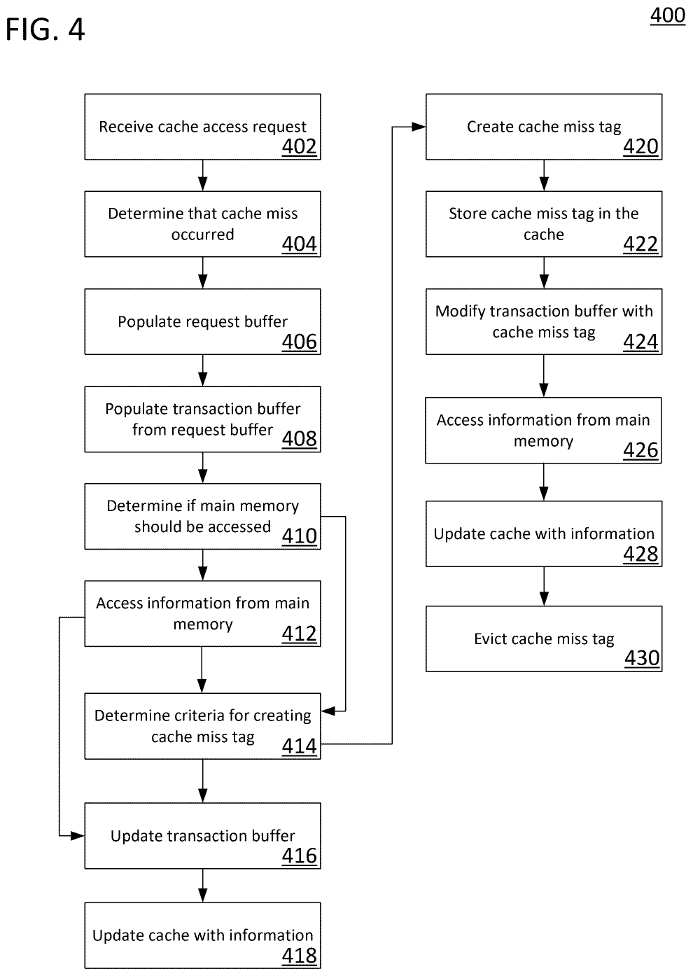

FIG. 4 depicts exemplary steps of a process 400 for cache miss monitoring and fulfillment in accordance with an embodiment of the present disclosure. In step 402, a processor can request data from a cache, such as an L1 cache. In step 404, it is determined that if the data is not present in the cache, the process 400 continues, otherwise there was no cache miss and processing continues normally. In step 406, a request buffer can be populated with information about the cache miss including the memory address referred in the cache access request. In step 408, the transaction buffer is populated with a transaction entry based on the location of the cache access request just stored in the request buffer.

In step 410, it is determined if main memory, which can be a lower-level cache or system memory, should be accessed to attempt to fulfill the missing data from the cache access request. In some cases, this step may be skipped proceeding directly to step 412. However, based on a variety of factors such as memory bandwidth, latency of the cache request, or prediction that the request buffer could be overwritten with information on a newer cache miss, it can be determined that the memory access should not take place at this time, and the process may skip ahead to step 414.

In step 412, main memory can be accessed to retrieve information requested from the cache access request. If accessed, the information can be placed in temporary storage within the request buffer, and the process can move to step 416. In some cases, the data cannot be retrieved, for many reasons, for example latency of retrieval becoming too high or stale data. In step 414, it is determined if a cache miss tag should be created in the cache miss tag section of the cache. In some cases, when information was not retrieved upon main memory access, it can be determined that the request buffer is unlikely to be overwritten, whereupon the process can loop back to step 410 to try accessing the data again. Otherwise, it can be determined that a cache miss tag should be created to replace the information in the request buffer. This may be more likely to happen when step 414 is reached directly from step 410 without a memory access attempt.

In step 416, the transaction buffer can be updated to invalidate the cache access request in the request buffer, and in step 418, the cache can be updated with the information contained in its temporary storage, thus fulfilling the data request.

In step 420, a cache miss tag can be created in a cache miss tag portion of the cache based on the cache access request. The cache miss tag can include similar address information as contained in the address portion of the request buffer for that cache access request, and in step 422, the address data is stored in the cache miss tag. In step 424, the transaction entry in the transaction buffer can be modified to now point to the newly created cache miss tag. In some cases the entry can be changed directly, but alternatively the entry can be deleted an a new entry created. In step 426, main memory can be accessed to retrieve information requested from the cache access request. If it is accessed, in step 428, the cache can be updated with the information retrieved. In some cases, information may not be able to be retrieved immediately, and the memory access can be repeated. In other cases, the process can move to step 430, where the cache miss tag can be evicted based on one or more criteria, for example, predicted time until overwriting of an entry in the request buffer, a sequence of the cache access request within a plurality of cache access requests of the request buffer, a notification, or a time since the request buffer entry was created. Step 430 is placed near the end of the process, but in some embodiments, this step can also be optionally executed during other portions of the process such as after step 408 or step 414 where it may be predicted preemptively that more room is needed in the request buffer.

In specific embodiments in the following paragraphs, a variety of elements may be present in a system pertaining to various means for performing actions.

A means for receiving a cache access request from a processing unit can include hardware implementations, such as a bus interface controller or a direct cache controller interface in the processor, or in some cases can be generated by a memory management unit that uses virtual addressing. Software implementations can include interrupt or other message-driven mechanisms that may be more applicable in multi-core processing environments, or else can include a software-defined cache access interface.

A means for determining that a cache miss has occurred based on a cache failing to fulfill the cache access request can include using a tag array or other lookup table to check if the memory request address is present in the cache. Logic circuits can also be used that track amount of time to return cache requests and flag a cache miss based on retrieval time and the cache level. The request buffer or an additional MSHR can be tracked for addresses present to determine if an ongoing cache miss is repeated.

A means for populating a request buffer based on the cache miss and the cache access request can include a FIFO queue structure, an MSHR based on fast registers or flip-flops, a content addressable memory (CAM) structure that can be searched quickly, or a software-controlled memory-mapped data structure using other fast memory. The structure can be flat with each entry corresponding to equal priority requests or can be organized hierarchically where some requests are assigned a higher priority. Higher priority data requests can also be flagged to be less likely to be transferred to a cache miss tag section for faster processing during times of high cache miss rate.

A means for populating a transaction buffer with a transaction entry for the request buffer based on the cache miss and the cache access request can include an indexed data structure capable of holding a reference to the request buffer or the cache miss tag section of the cache. Other implementations are a linked list with dynamic allocation, or a CAM-based transaction buffer for fast matching. It can also include a dual stage pipeline that can temporarily store and then asynchronously process transaction entries to allow multiple cache misses to be handled simultaneously.

A means for determining, by the request buffer, that information requested in the cache access request should be retrieved from main memory can include software heuristics using cache miss rate, request buffer size, and average and recent memory retrieval times to calculate whether data can be retrieved before incoming cache miss events flood the system. Heuristics also can be implemented in the transaction buffer based on population of both the request buffer and the cache miss tags.

A means for determining, by the transaction buffer, if the information was not retrieved, that the cache access request satisfies criteria for creating a cache miss tag can include state-based tracking of each active entry in the transaction buffer with time thresholds for pending requests in the request buffer. It can also include cache hit/miss data for this level cache and other cache levels. The means can include logic circuitry to analyze cache miss rate, request buffer size, and average and recent memory retrieval times to determine or predict if request buffer entries may be overwritten or can preemptively choose to transfer request buffer information to a cache tag while there is space remaining based on predictive trends.

A means for creating the cache miss tag based on the cache access request can include a tag generator, an encoding mechanism, or a memory-mapped table that produces and stores a cache miss identifier corresponding to the access request. The address and way can be explicitly stored in the transaction entry address, or the way can be implicitly contained in the addressing scheme. The encoding can include additional metadata such as validity, access type, priority levels, or timestamps.

A means for storing the cache miss tag in a portion of the cache can include a reserved section of cache memory, a cache index structure, or a dedicated cache miss tracking table that records the cache miss tags that may be distributed in the cache. Miss tags can also be stored using a hardware-controlled least-recently-used (LRU) policy that may facilitate later evictions if needed. Cache miss tags can also be dynamically managed where the size of the cache miss tag section can be dynamically allocated based on system load, data cache needs, and cache miss rates.

A means for accessing, by the request buffer, a main memory for information requested in the cache access request can include a direct memory controller interface from the request buffer to lower-level memory, or a bus-based request with priority handling if system memory is the lower-level memory. It may also include a prefetching mechanism if other predictive caching hardware is present, and the request buffer can be optionally integrated with portion as well. The request buffer can use a split-transaction protocol to initiate memory access requests, which allows it to process other overlapping cache miss access requests.

A means for updating the transaction buffer based on whether the request buffer accessed the information can include an event-driven control unit with a callback system to update the transaction buffer entry if the request buffer memory access request was successful. It can include a status update mechanism to update flags in the transaction buffer associated with the request buffer data, or other state-tracking logic.

A means for updating the cache with the information when the request buffer successfully accessed the information can include various mechanisms to write retrieved data efficiently while keeping cache coherence, including a write-through cache update mechanism for propagating information through a hierarchy, write-back with dirty bit tracking, or set-associative cache insertion with replacement policy handling. The cache update may also use non-blocking cache assertion to coordinate with the request buffer information but allow the cache write to continue asynchronously while the request buffer can process additional requests. Cache updates can also be integrated with other cache prefetch policies implemented in the system.

A means for modifying the transaction entry to refer to the cache miss tag can include an address remapping function using an index field. The pointer or index can refer to an address or may refer to an internal mapping in the cache table. The transaction buffer as well as entries can be dynamically adjusted based on current and projected load of pending cache miss requests. It can also include mechanisms to poll or otherwise search the valid addresses of pending requests within the transaction buffer to determine open spaces within the cache miss tag section for allocation of the address.

A means for deleting or invalidating the transaction entry can include mechanisms to change a validity flag in the transaction entry for the associated request buffer or cache miss tag, a garbage collection algorithm or other deletion queue, or overwrite-based entry deletion for reallocation. In implementations using linked lists, a mechanism to reset the internal pointers to skip the transaction entry and deallocate the memory can be used.

A means for populating a new transaction entry in the transaction buffer referring to the cache miss tag was described previously in the similar means for modifying the transaction entry to refer to the cache miss tag.

A means for accessing the main memory for information requested in the cache access request based on the cache miss tag was described previously with reference to the means for accessing, by the request buffer, the main memory for information requested in the cache access request.

A means for updating the cache with the information when the information is successfully accessed was described previously in the similar means for updating the cache with the information when the request buffer successfully accessed the information.

A means for updating the transaction entry based on the cache being updated can include transaction record modification circuit that updates a status flag within the transaction entry, or an event-driven update mechanism that includes callbacks or interrupts when new data is written to the cache. This allows asynchronous cache updates without constant polling of cache lines. Age-based tracking mechanisms can also record when a cache line has last been updated to determine if any cache miss tags should be evicted.

A means for modifying a pointer type and an address of the transaction entry can include pointer redirection logic, an address remapping unit, or a dynamic reference table that alters the memory location or type association of transaction entries contained within the cache or in other fast memory.

A means for evicting a cache entry based on an eviction criteria can include a least-recently-used (LRU) policy manager that determines oldest cache miss tags which is least likely to be fulfilled. It can also use an age-based tracker to one or both of the transaction entry time or the cache line access to determine, a frequency-based replacement mechanism based on sections of memory addressed, or a priority-based invalidation logic that determines and removes cache entries based on predefined criteria.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed is:

1. A method for cache miss monitoring and fulfillment, comprising:
receiving, from a processing unit, a cache access request;
determining, based on a cache failing to fulfill the cache access request, that a cache miss has occurred;
populating a request buffer based on the cache miss and the cache access request;
populating a transaction buffer with a transaction entry for the request buffer based on the cache miss and the cache access request;
determining by the request buffer, that information requested in the cache access request should be retrieved from main memory;
determining, by the transaction buffer if information was not retrieved, that the cache access request satisfies criteria for creating a cache miss tag;
creating the cache miss tag based on the cache access request; and
storing the cache miss tag in a portion of the cache.

2. The method of claim 1, further comprising:
accessing, by the request buffer, a main memory for information requested in the cache access request; and
updating the transaction buffer based on whether the request buffer accessed the information.

3. The method of claim 2, further comprising updating the cache with the information when the request buffer successfully accessed the information.

4. The method of claim 1, further comprising modifying the transaction entry to refer to the cache miss tag.

5. The method of claim 1, further comprising:
deleting or invalidating the transaction entry; and
populating a new transaction entry in the transaction buffer referring to the cache miss tag.

6. The method of claim 4, further comprising:
accessing the main memory for information requested in the cache access request based on the cache miss tag; and
updating the cache with the information when the information is successfully accessed.

7. The method of claim 6, further comprising updating the transaction entry based on the cache being updated.

8. The method of claim 7, wherein the updating of the transaction entry comprises modifying a pointer type and an address of the transaction entry.

9. The method of claim 1, further comprising evicting a cache entry based on an eviction criteria, wherein the eviction criteria comprises one of a predicted time until overwriting of an entry in the request buffer, a sequence of the cache access request within a plurality of cache access requests of the request buffer, a notification, or a time since the entry in the request buffer was created.

10. The method of claim 1, wherein the transaction entry comprises a location of the cache access request within the request buffer.

11. The method of claim 1, wherein each entry within the transaction buffer is identifiable as a cache miss tag entry type or a request buffer entry type based on a value within each entry.

12. The method of claim 11, wherein each entry within the transaction buffer includes a pointer to the request buffer or to a cache miss tag portion of the cache, and wherein whether the pointer points to the request buffer or the cache miss tag portion is based on the value.

13. The method of claim 12, wherein a size of each entry within the transaction buffer is at least an order of magnitude less than a size of each entry within the request buffer.

14. The method of claim 1, wherein a number of entries within the transaction buffer is at least five times greater than a number of entries within the request buffer.

15. The method of claim 14, wherein the number of entries within the transaction buffer allows at least four times as many entries of a cache miss tag entry type as entries of a request buffer entry type.

16. The method of claim 15, wherein the number of entries within the transaction buffer is eight times greater than the number of entries within the request buffer and wherein the number of entries within the transaction buffer allows at least seven times as many entries of the cache miss tag entry type as entries of the request buffer entry type.

17. A system for cache miss monitoring and fulfillment, comprising:
means for receiving a cache access request from a processing unit;
means for determining that a cache miss has occurred based on a cache failing to fulfill the cache access request;
means for populating a request buffer based on the cache miss and the cache access request;
means for populating a transaction buffer with a transaction entry for the request buffer based on the cache miss and the cache access request;
means for determining, by the request buffer, that information requested in the cache access request should be retrieved from main memory;
means for determining, by the transaction buffer, if the information was not retrieved, that the cache access request satisfies criteria for creating a cache miss tag;
means for creating the cache miss tag based on the cache access request; and
means for storing the cache miss tag in a portion of the cache.

18. The system of claim 17, further comprising:
means for accessing, by the request buffer, a main memory for information requested in the cache access request; and
means for updating the transaction buffer based on whether the request buffer accessed the information.

19. The system of claim 18, further comprising means for updating the cache with the information when the request buffer successfully accessed the information.

20. The system of claim 17, further comprising means for modifying the transaction entry to refer to the cache miss tag.

21. The system of claim 17, further comprising:
means for deleting or invalidating the transaction entry; and
means for populating a new transaction entry in the transaction buffer referring to the cache miss tag.

22. The system of claim 20, further comprising:
means for accessing the main memory for information requested in the cache access request based on the cache miss tag; and
means for updating the cache with the information when the information is successfully accessed.

23. The system of claim 22, further comprising means for updating the transaction entry based on the cache being updated.

24. The system of claim 20, wherein the means for updating the transaction entry comprises means for modifying a pointer type and an address of the transaction entry.

25. The system of claim 17, further comprising means for evicting a cache entry based on an eviction criteria, wherein the eviction criteria comprises one of a predicted time until overwriting of an entry in the request buffer, a sequence of the cache access request within a plurality of cache access requests of the request buffer, a notification, or a time since the entry in the request buffer was created.

26. The system of claim 17, wherein the transaction entry comprises a location of the cache access request within the request buffer.

27. The system of claim 17, wherein each entry within the transaction buffer is identifiable as a cache miss tag entry type or a request buffer entry type based on a value within each entry.

28. The system of claim 27, wherein:
each entry within the transaction buffer includes a pointer to the request buffer or to a cache miss tag portion of the cache; and
whether the pointer points to the request buffer or the cache miss tag portion is based on the value.

29. The system of claim 28, wherein a size of each entry within the transaction buffer is at least an order of magnitude less than a size of each entry within the request buffer.

30. The system of claim 17, wherein a number of entries within the transaction buffer is at least five times greater than a number of entries within the request buffer.

31. The system of claim 30, wherein the number of entries within the transaction buffer allows at least four times as many entries of a cache miss tag entry type as entries of a request buffer entry type.

32. The system of claim 31, wherein:
the number of entries within the transaction buffer is eight times greater than the number of entries within the request buffer; and
the number of entries within the transaction buffer allows at least seven times as many entries of the cache miss tag entry type as entries of the request buffer entry type.

33. A system for cache miss monitoring and fulfillment, comprising:
a processing unit configured to generate memory access requests,
a cache communicatively coupled to the processing unit for storing frequently accessed data,
a memory subsystem comprising lower level memory coupled to the cache and configured to fulfill memory access requests that may result in cache misses;
a request buffer coupled to the cache, the request buffer configured to track memory access requests corresponding to cache misses; and
a transaction buffer coupled to the cache and the request buffer, configured to indirectly track status of cache misses using transaction entries which can reference either an entry in the request buffer or an entry in a cache miss tag section;
wherein: (i) the lower level memory comprises a lower level cache or system memory; (ii) the transaction buffer is configured to monitor the request buffer to determine if data may be lost from the request buffer; and (iii) memory access requests corresponding to cache misses are moved to a cache miss tag in a section of the cache whereupon the transaction entry is updated to point to the cache miss tag.
